(19) United States
(12) Patent Application Publication
(10) Pub. No.: US 2003/0066875 A1
(43) Pub. Date: Apr. 10, 2003

(54) Apparatus for counting people or objects

(75) Inventor: Alain Rouet, Manerbe (FR)

Correspondence Address: SCHNADER HARRISON SEGAL & LEWIS, LLP, 1600 MARKET STREET, SUITE 3600, PHILADELPHIA, PA, 19103

(73) Assignee: Quantaflow

(21) Appl. No.: 10/238,875

(22) Filed: Sep. 9, 2002

Related U.S. Application Data
(63) Continuation of application No. PCT/FR01/00715, filed on Mar. 9, 2001.

(30) Foreign Application Priority Data
Mar. 10, 2000 (FR) FR 00/03121

(51) Int. Cl. G06F 17/00

(52) U.S. Cl. 235/375

(57) ABSTRACT

A device for counting people or objects in a passageway including an information processing control until and an optical sensor positioned above the passageway, the optical sensor including two identical charge coupled modules which are linear and fixed parallel to each other and transversely to the passageway and separated from each other by a distance D enabling the processing unit to determine in real time an entering and leaving direction of each movement in the passageway and a total number of movements in the passageway, wherein the processing unit monitors the temporal evolution of background noise sensed by the optical sensor for extracting crude modifications due to the passage of a person or object.

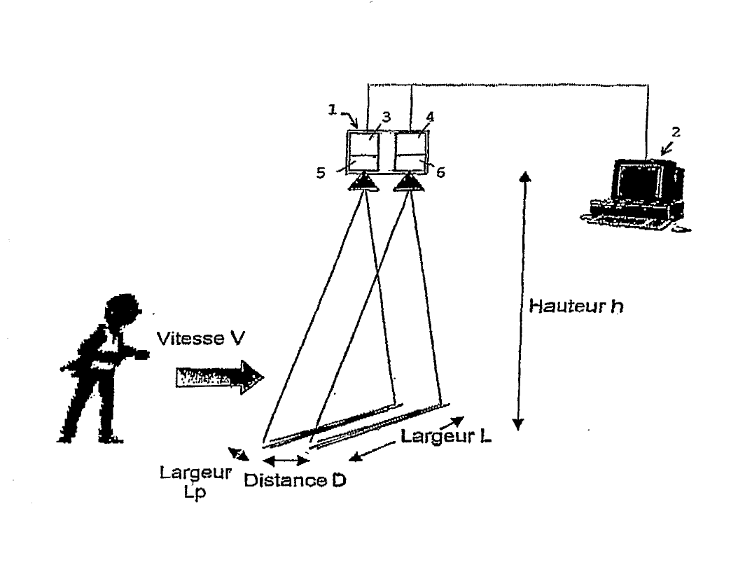

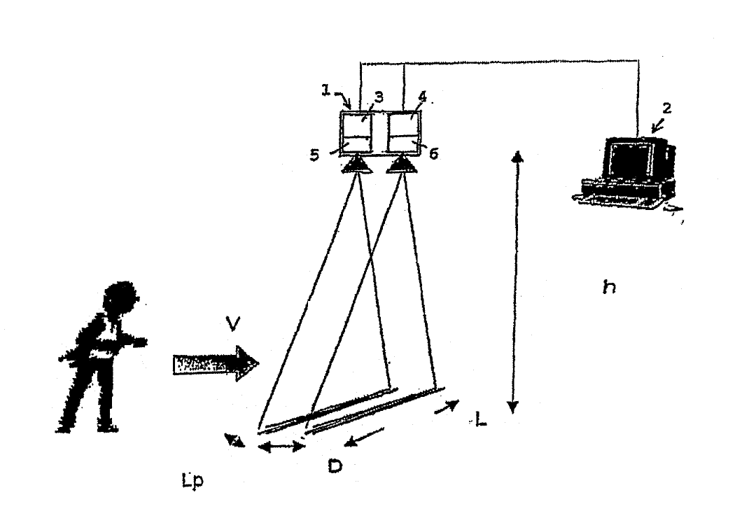

The present invention pertains to devices for counting people or objects, particularly people moving in a passageway of a certain width that can accommodate multiple people over the width.

The sensors used for counting people can be grouped essentially into three categories:

1—active sensors: they emit, e.g., an infrared beam. In the absence of people, this beam is not reflected. If a person passes, the beam is reflected off the person and this reflection is detected.

2—control line sensors: a control line (luminous tube, painted line, painted checkerboard pattern, etc.) is detected permanently by the sensor except during passage of a person who hides or modifies the signal. These systems require an installation on the floor;

3—passive sensors without control line (video camera, for example) which record the useful zone and operate on its modifications over time.

These three categories are completely unrelated and based on different physical principles.

Known in the first category is French patent application no. 2,739,203 which pertains to a device for counting people or objects presenting as a unit or simultaneously in one and/or the other direction of relative movement in relation to the device.

Such a device comprises essentially:

a set of detectors, each of the electromagnetic wave transmitter/receiver type arranged in a manner such that the people or objects have a relative movement in relation to said set,

a control circuit intended to sequentially activate the set of detectors such that they provide sequential signals representative of the presence or absence of a person or an object in the field of the activated detector, and

a circuit for processing the signals stemming from the detectors during multiple successive sequences so as to detect the passage of people or objects and count them.

In practice, such a known counting assembly can present itself, for example, in the form of a fixed ramp positioned at a certain height above the floor and forming a series of detectors each of which emits an almost parallel beam of infrared, visible or ultraviolet light, a part of which is reflected to the associated receiver in the presence of a person or object to be detected.

In the absence of people or objects, the beam reaches the floor. The reflection to the detector must then be below the threshold of detection so as to not saturate the detector.

In fact, it must be understood that since the emitted beams are almost parallel, the spot directed on the obstacle is smaller than the obstacle irrespective of its distance.

In contrast, after reflection on the obstacle, the beam is reflected/diffused in all directions or at least in a solid angle much larger than the one on which one sees the detector from the obstacle. The quantity of energy received by the detector thus decreases as the square of the distance to the obstacle. This problem is resolved for low heights by the method described in French patent no. 2,779,832 but the calculations show that such a device cannot operate correctly at greater heights.

French patent application no. 2,586,821 is known in the second category. It pertains to a device for counting people or objects: detection is based on the observation of the absence of reflection of a reflective reference mark constituted by one or more control lines (A, B) which are crossed over by moving objects. Passage is deduced from this absence of reflection.

It was certainly envisaged to not actually materialize the reference mark but rather to use the floor directly, but the floor must then “present an elevated reflective power”, as described on page 7, lines 19 to 22, so as to enable visualization by reflection from the control line.

The major disadvantage of this type of device is that it requires the presence of a reflective reference mark or a reflective floor, but this aspect is very difficult to take into consideration when designing a building since it has a negative influence on the esthetic appearance of the passageway.

One of the difficulties in the implementation of systems in the third category stems from the noise that is inherent in all video images. The variation of a given pixel upon passage of a person or an object can be of the same order of magnitude as the fluctuations due to the noise, especially when the person's clothing or the color of the object are colors similar to the background color, obviously making it very difficult to detect passage.

In solutions using a video camera, this problem is resolved by the redundancy of the information due to the availability of a large number of lines.

The objective of the present invention is to propose a counting device that is more reliable, more effective and less expensive than the devices of the prior art.

The counting device according to the invention is of the third category. Thus, there is no constraint related to materialization of reflective reference marks.

The present invention faces the phenomenon using only a single detection line. This solution makes it possible to limit the memory of the processor and to have launched processing. The problem of noise is handled by means of a preprocessing algorithm.

That which distinguishes the present invention in relation to the video cameras used until now is the fact that only two CCD modules are used.

In its most general meaning, the present invention pertains a device for counting people or objects according to claim 1.

According to other characteristics of the invention:

an optic constituted by one or two objectives is associated with two optical sensor modules such that their virtual linear images present a length at least equal to the width of the passageway to be monitored,

the device is positioned at a height between 3 m and 10 m above the passageway to be monitored,

the device is entirely digital, the analog signal stemming from each module being immediately transformed into a digital signal in an associated analog/digital converter after amplification.

Other characteristics and advantages of the invention will become clear from the description below with reference to the attached drawing which schematically represents a device for counting people or objects according to the invention.

With reference to the single FIGURE, a sensor device for people or objects according to the invention comprises essentially an optical sensor, which is designated in a general manner by 1, and a control and computer processing unit such as a computer or, more precisely, a microprocessor 2.

The device for counting people or objects according to the invention is intended to be positioned above the passageway to be monitored and one of the axes is perpendicular to the direction of the movement of the people or objects moving in said passageway.

The sensor 1 is constituted by two charge coupled (CCD) modules 3, 4, which are linear, identical, parallel, fixed parallel in relation to each other and transversely in relation to the passageway to be monitored. They are positioned at a height h, transversely in relation to the width L of the passageway to be monitored and separated from each other by a sufficient distance D that enables the control microprocessor 2 to ensure processing, i.e., counting, it being understood that one of the axes of the sensor 1, i.e., of each module 3 and 4, is perpendicular to that of the movement of the people or objects.

In fact, in the sensor 1 the two modules 3 and 4 are required for obtaining two images, each corresponding to a virtual line on the floor of very small width Lp, enabling the microprocessor 2 to determine the direction of passage, entering or leaving, as well as the number of passages, their velocity V, taking into account the ambient light which can be store-type lighting.

Said processing unit performs a tracking of the temporal evolution of the background by the optical sensor (1) for extraction of the crude modifications due to passage of said person or said object.

It should be noted that the data acquisition and counting processing are performed in real time by the microprocessor 2.

The modules 3 and 4, for example, of the 1024-pixel, 2048-pixel, 3000-pixel or higher type depending on the technology of the module and the electronic control shutter. The photosensitive line of each module 3 or 4 is associated with an analog charge transfer register protected from the light and charged to transmit sequentially each information on the sensor output.

From the lines of pixels that it recovers, the microprocessor 2 evaluates whether the sensor elements provide a sufficiently high signal and manage the control signals from the modules as explained below.

Furthermore, because the output of each module 3 or 4 is an analog signal, it is necessary to place between the modules and the microprocessor an analog/digital converter which converts the analog pixels into digital values that can be read directly by the microprocessor.

So as to have available a regulation stage in addition to the electronic shutter, two digital potentiometers are preferably placed between the pixel output signal and the converter to control the gain and shift of the operational amplifier. It is thereby possible to adjust the analog signal in the range provided by the two voltage references of the converter.

The analog/digital converter outputs levels of gray comprised typically between 0 and 255, or more, and receives two reference voltages corresponding respectively to the analog levels of the black and the white.

From the mechanical point of view, in order to have on the floor virtual lines presenting the desired width L, it is necessary to place the modules 3 and 4 behind one or preferably two associated optics 5 and 6, for example optics of focal length 28 mm which enables visualization of passage for heights ranging from 3 to 10 m.

It should be taken into account that the visual field on the floor is directly proportional to the height of the installation. Thus, if the device is placed at a height of 6 m, it will cover a field of 6 m on the floor.

The distance between the modules, e.g., 5 cm, is calculated such that the person or object passing under the device first appears on one line and then on the other line because the direction of movement is determined by the temporal shift of the two lines.

Thus, the microprocessor 2 manages the monitoring of the two modules 3 and 4, and has available, e.g., every 15 ms, two lines of 2048 pixels with a resolution of 255 levels of gray.

The microprocessor bases its data processing on these lines and evaluates the lighting level of the site for adjusting the gain and the amplification threshold as well as the shutter-closed time of the modules.

In a general manner, we can consider that the microprocessor 2 will extract the information pertaining to the passage of a person as well as his direction of movement from the 2048-pixel lines couples that are provided to it.

This processing is performed in two steps:

a preprocessing algorithm consisting of extracting from two lines of 2048 pixels in 255 levels of gray, a line, e.g., of 256 0 or 1 values representing the simplified trace of the passage under a group of module cells (macropixels). This first algorithm consists of extracting from the image a spot corresponding to the passage of a person or an object by eliminating the shadows and also processing the variations in lighting.

a counting algorithm, i.e., processing of forms, which brings to light each line of e.g., 256 bits of information on the person or object during the course of passage and which decides, based on criteria of velocity, width, length and direction, whether it presents a valid form to be finally counted. This second algorithm processes the complicated cases of people crossing in front of each other, following each other in Indian file, presenting multiple times or changing direction. It corresponds, e.g., to the algorithm described in the previously cited French patent no. 95 11 328.

It is clear that the present invention was described and represented for explanatory purposes but not in any limitative terms and that one could introduce useful modifications, especially in the domain of technical equivalences, without going beyond the scope of the invention.

1. Device for counting people or objects comprising a detection and counting unit intended to be positioned above the passageway to be monitored and one of the axes of which is perpendicular to the direction of the movement of the people or objects moving in said passageway, characterized by the fact that the detection unit comprises an optical sensor (1) and an information processing control unit, the optical sensor being constituted by two charge coupled modules (3, 4), which are linear, identical, fixed parallel in relation to each other and transversely in relation to the passageway to be monitored and separated from each other by a sufficient distance D to enable the processing unit that controls them to determine in real time the entering and leaving direction of each movement as well as the total number of movements, said processing unit performing a monitoring of the temporal evolution of the background sensed by the optical sensor (1) for the extraction of the crude modifications due to the passage of said person or said object.

2. Device according to claim 1, characterized by the fact that an optic, constituted by one or two objectives (5, 6), is associated with the two modules (3, 4) of the optical sensor (1) such that their virtual linear images present a length that is as least equal to the width (L) of the passageway to be monitored.

3. Device according to one of claims 1 or 2, characterized by the fact that it is positioned at a height (h) comprised between 3 m and 10 m above the passageway to be monitored.

4. Device according to any one of claims 1 to 3, characterized by the fact that it is completely digital, the analog signals output by each module (3 or 4) being transformed into a digital signal in an associated analog/digital converter after amplification.

5. Device according to any one of the preceding claims, characterized by the fact that each module (3 or 4) corresponds to a large number of pixels (1024, 2048, 3000 or more), that the converter transforms typically 256 gray level values for each pixel, that the preprocessing algorithm then transforms into 0 or 1 values for a more reduced number of macropixels (128 or 256), these 0 or 1 values of the macropixels then being processed according to an algorithm.

6. Device according to any one of claims 1 to 5, characterized by the fact that the exposure times of the two charge coupled modules (3, 4) are adjusted electronically via the electronic shutter of the modules by a software program in real times in relation to the mean levels, the devices thereby adapting to variations in the lighting.

7. Device according to claim 6, characterized by the fact that the adjustment of threshold and gain is performed downstream of the signal of each charge coupled module (3, 4) by means of an operational amplifier associated with two digital potentiometers.

8. Device according to any one of the preceding claims, characterized by the fact that the microprocessor (2) can be replaced by multiple microprocessors and/or microcontrollers and or digital signal processing devices, programmable logic, launched microcomputers or, in a general manner, by any electronic cards comprising intelligence.
Key to figure
Vitesse=velocity
Largeur=width
Distance=distance
Hauteur=height
